(19) United States
(12) Patent Application Publication
(10) Pub. No.: US 2006/0125321 A1
(43) Pub. Date: Jun. 15, 2006

(54) Electrically operated product, circuit for allowing a backup battery to be physically connected without being electrically connected

(76) Inventor: Donald Olsen, Smithtown, NY (US)

Correspondence Address: Gerald T. Bodner;Bodner & O'Rourke, LLP, Suite 108, 425 Broadhollow Road, Melville, NY, 11747, US

(21) Appl. No.: 11/297,000

(22) Filed: Dec. 8, 2005

Related U.S. Application Data
(60) Provisional application No. 60/636,404, filed on Dec. 15, 2004.

(51) Int. Cl. H02J 9/00

(52) U.S. Cl. 307/66

(57) ABSTRACT

A control circuit for selectively allowing a backup battery to be physically connected to a load without being electrically connected to the load includes a bistable multivibrator circuit, a power-to-load switching circuit connected to the multivibrator circuit, a delay circuit and a sleep state switching circuit. The multivibrator circuit is in a first sleep state when the backup battery is connected to the control circuit but no voltage is supplied to the control circuit from the power supply. Under these circumstances, the control circuit provides no power supply voltage or backup battery voltage to the load. The multivibrator circuit changes to a second state from the first state when a power supply voltage is provided to the control circuit after the multivibrator circuit is already in the first state. Then, the control circuit will provide either the power supply voltage or the backup battery voltage to the load. The multivibrator circuit remains in the second state unless it receives a signal from the sleep state switching circuit which places it back into the first sleep state.

### CROSS-REFERENCE TO RELATED APPLICATION

This application is related to U.S. provisional patent application Ser. No. 60/636,404, filed on Dec. 15, 2004, and entitled “In an Electrically Operated Product, Circuit for Allowing a Backup Battery to be Physically Connected Without Being Electrically Connected”, the disclosure of which is incorporated herein by reference. This application claims the benefit of priority under 35 U.S.C. 119 to the aforementioned related provisional application.

### BACKGROUND OF THE INVENTION

1. Field of the Invention

The present invention relates to an electronic circuit, designed for utilization in electrically operated devices which normally operate using standard AC line voltage as a power source, and which said devices also incorporate a backup battery as a secondary power source when AC line voltage is not available, such as during a power failure.

2. Description of the Prior Art

A number of circuits, such as emergency lighting circuits, are powered by AC line voltage but have a rechargeable backup battery as a secondary power source when the AC line voltage is not available. In many such circuits, relays are used to switch in the backup battery to provide power to the light or other circuit in an emergency situation when the AC power has failed. However, such a relay configuration requires a relatively large amount of current drawn from the backup battery in order to connect the battery to the light or other circuit.

A problem may occur when an appliance or emergency light having a backup battery is first installed in a building, office, store or other premises under construction or renovation before AC power has been applied. If the backup battery is connected to the circuit prior to AC line voltage being supplied, obviously the backup battery will provide power to the emergency light or other circuit until the battery is entirely drained. Accordingly, installers may be required to remove the backup battery from the circuit until AC line voltage is available in the premises. This requires a return trip by the installer to the premises to reconnect the backup battery so that the backup battery will remain charged by its connection to the AC line voltage, and current will only be drawn from the backup battery when there is a power failure.

There are a number of patents which describe circuits that place a backup battery in what is commonly referred to as a “sleep mode”. These include, for example, U.S. Pat. No. 6,144,186, which issued to Iilonga Thandiwe et al.; U.S. Pat. No. 6,075,742, which issued to Tom Youssef et al.; and U.S. Pat. No. 6,545,447, which issued to Gregory J. Smith. In the “sleep mode” operating condition, most if not all of the prior art circuits, for example, that disclosed in the Smith patent, draw very little current from the backup battery until the backup battery is “awakened” when a charge or load is applied to the battery that exceeds a predetermined threshold. Such a circuit does not solve the problem of having the backup battery physically connected to the load without being electrically connected, as once a load is placed on the battery without AC line voltage being connected to the circuit, the battery will be awakened from its sleep mode and provide current to the emergency light or other circuit to which it is connected.

### OBJECTS AND SUMMARY OF THE INVENTION

The purposes of this circuitry are firstly, to provide a means for a backup battery to be physically connected at all times to the aforementioned device, secondly, to provide a means for the backup battery to become electrically connected to the device when AC line voltage is first supplied, thirdly, to provide a means for the backup battery to remain electrically connected to the device as a secondary power source whenever AC line voltage is subsequently terminated such as during a power failure, and lastly, to consume a minimal amount of current while performing all of these functions. Devices incorporating this circuitry will have the capability of being shipped from the manufacturer or to a customer with a charged battery pre-connected physically, but not electrically, as previously described. A typical application for this circuitry would include devices which may be installed before AC power is available, such as in new construction, and would include such devices as emergency lighting or monitoring equipment such as temperature alarms, security systems, smoke detectors and the like. A significant advantage of this circuitry is that, in scenarios such as the one previously described regarding new construction, it would eliminate the need of having personnel return to a facility to physically connect the battery once AC power is available.

It is possible to perform the functionality for which this circuitry is intended by using a latching relay, but there are a number of significant advantages that this circuitry offers over a relay based configuration: firstly, the circuitry, which will be subsequently disclosed, is less expensive than utilizing a relay, secondly, this circuitry can be configured in less space than a relay would require, making it possible to easily have the circuitry added to the respective device or even built into the battery itself, and thirdly, this circuitry will consume an extremely small fraction of the current required by a relay configuration. This last advantage is of particular importance when a device utilizing this circuitry is actually operating off of the battery, such as during a power failure. At such times, the life of the battery is dependent on the amount of current that is being drawn by the circuitry that it is powering. The minimal amount of current that is drawn by this circuitry will help to prolong battery life when such power failures occur.

In accordance with one form of the present invention, a circuit which allows a backup battery to be physically connected without being electrically connected includes a control circuit having a bistable multivibrator which senses whether the backup battery is connected to the circuit and the load prior to AC line voltage being supplied to the circuit. The circuit of the present invention allows the backup battery to be physically connected to the load, but not electrically connected, during the condition when AC line voltage has not yet been supplied to the circuit. The circuit of the present invention also senses the presence of AC line voltage and, accordingly, changes state to allow power to be supplied to the load either by the backup battery or the AC line voltage.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a schematic of the aforementioned circuitry of the present invention as utilized in a typical application.

FIG. 2 is a schematic of a variation of the circuitry shown in FIG. 1 and formed in accordance with the present invention.

### DETAILED DESCRIPTION OF THE PREFERRED EMBODIMENTS

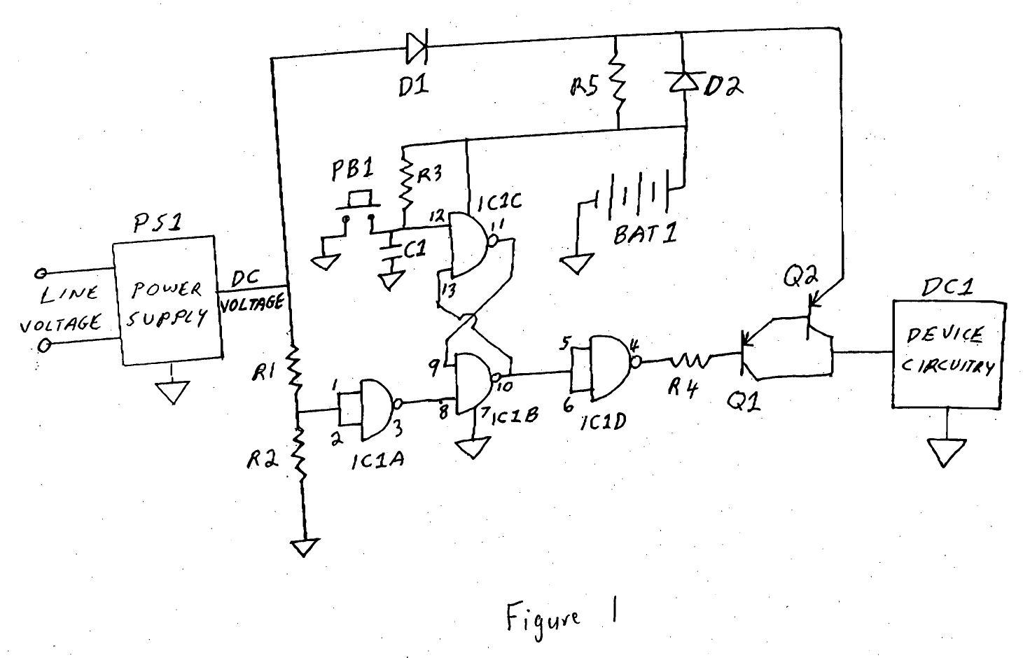

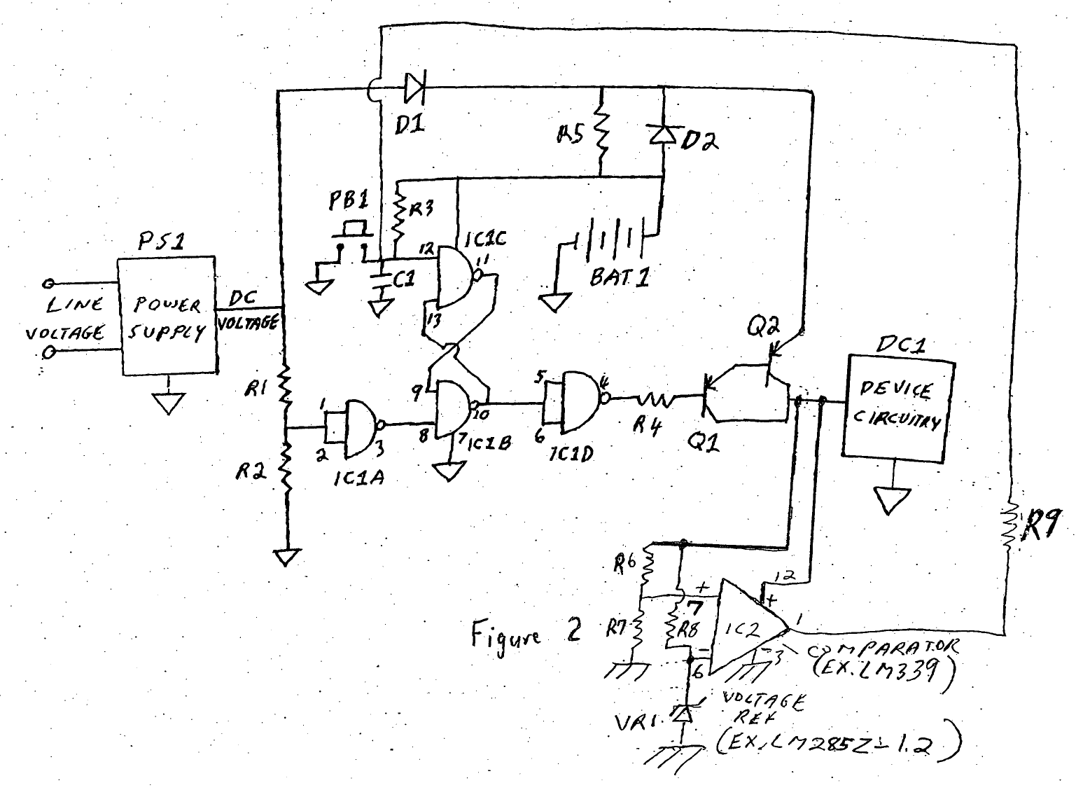

With reference to FIGS. 1 and 2, a description of the control circuit of the present invention will now follow.

PS1 is a block representation of a typical power supply, which is designed to take AC line voltage, normally 120VAC, change the line voltage to a lower voltage and then convert the lower voltage to DC voltage. This resultant lowered DC voltage is typically what is required to operate many electrical or electronic devices, and PS1 is the primary power source for device operation. BAT 1 is a battery, such as a 6 volt rechargeable battery, which serves as a secondary source of device operation when PS1 is not activated, such as during a power failure. D1 and D2 are diodes such as a 1N4001, and they are configured so that, while voltage supplied by PS1 and BAT 1 are joined as one power source for device operation, power from PS1 cannot feed back into BAT 1, and power from BAT1 cannot feed back into PS1. The joined cathode connection of D1 and D2 is then connected to the emitter of Q2. Q1 and Q2 are PNP transistors such as a PN2907, connected in a Darlington configuration, and together, Q1 and Q2 serve as a switch (i.e., a power-to-load switching circuit) for turning power, received from the cathode junction of D1 and D2, on and off to DC1, DC1 being the device circuitry operated by PS-1 or BAT1. If the base of Q1 is HI, (logic 1), then power to DC1 will be off. If the base of Q1 is LO, (Logic 0), then power to DC1 will be on.

Central to the circuit operation is IC1A, IC1B, IC1C and IC1D, which together, comprise a four input NAND gate integrated circuit, wholly identified as IC1. Many of the other electronic devices heretofore and hereinafter described, such as Q1, (PN2907), or D1, (1N4001), are typical devices which may be interchanged with other similar devices. This however, is not so of IC1. In the preferred embodiment, IC1 is a CMOS device, identified as part #4011. While there are a number of other similar devices to the 4011 in terms of logic function, the two important advantages of the 4011 are that firstly, the 4011 has a wide operating voltage range (3-18 VDC, typical), making it suitable for application in power supply/battery configurations of different voltages, and secondly, the 4011 consumes very little current (6 μuA.), thereby causing a minimal current drain while performing its intended tasks. IC1B and IC1C are configured in the circuit so as to create a bistable multivibrator circuit or “flip flop”, a circuit which functions as a one bit memory. Pin 8 of IC1B and Pin 12 of IC1C are inputs to the flip flop, and Pin 10 of IC1B (also including Pin 13 of IC1C by means of connection in the circuitry), is the output of the flip flop. The truth table of any one of the four NAND gates comprising IC1 is as follows: If either or both inputs=0, the output=1. If both inputs=1, the output is 0. Therefore, with IC1B and IC1C configured as shown, the output of the flip flop will be at either 0 or 1, depending on the last 0 that is present at either of the inputs. If the last 0 is at Pin 8 of IC1B, then the output will be 1. If the last 0 is at Pin 12 of IC1C, then the output will be 0. The remaining NAND gates comprising IC1, IC1A and IC1D, are configured to operate as inverters: A 0 on the input produces a 1 on the output and a 1 on the input produces a 0 on the output. R1 and R2 provide a voltage divider network at the input of IC1A. The resistance value of R1 and R2 will vary, depending on the operating voltage of PS1 and BAT1. If PS1 is on, a voltage (logic 1) will be supplied at the input of IC1A. If PS1 is off, this will supply a 0 at the input of IC1A. In the absence of voltage from PS1, the input of IC1 will be pulled to ground (logic 0) by R2. R3 and C1 provide an RC network defining an integrator circuit at the input of IC1C, which integrator circuit functions as a delay circuit for the signal received at the Pin 12 input of IC1C, which is either the backup battery voltage or the power supply voltage. If voltage is applied across R3 and C1, the junction of R3 and C1 (also connected to the input of IC1C) will momentarily be logic 0 and then will rise to logic 1 as C1 charges through R3. PB1 is a momentary pushbutton switch, providing a means for manually making the input of IC1C a logic 0 when so desired to put the control circuit back into sleep mode.

Based upon the aforementioned logic description, circuit operation is as follows: If BAT1 is connected prior to PS1 providing power, the input of IC1A will be 0 and the output of IC1A will be 1. Therefore, the input of IC1B (Pin 8) will be 1. Simultaneously, the input of IC1C (Pin 12) will be 0 temporarily and then will rise to 1 as C1 charges. Therefore, the last 0 will be at Pin 12 of IC1C and the output of the flip flop (Pin 10) will be 0. This 0 is then inverted by IC1D so that a logic 1 (through R4, which is a current limiting resistor) appears at the base of Q1. As a result, the switch formed by Q1 and Q2 is off and device circuitry is not activated. At this time, BAT1 is physically connected to DC1, but it is not electrically connected, and both inputs of the flip flop are at logic 1. This is considered to be a “sleep” condition for BAT1, whereby the only circuitry being activated is the described circuit itself. At this time, total current draw from BAT1 is 6 μA., which is the current required to operate the IC1. When PS1 is turned on, the presence of voltage at R1 makes the input of IC1A a logic 1, which then gets inverted to a 0 by IC1A so that Pin 8 becomes a logic 0, where it will remain for as long as PS1 is on. The result is that the output of the flip flop (Pin 10) changes to logic 1, which then gets inverted by IC1D, so that the base of Q1, through R4, is now 0, and as a result, the switch formed by Q1 and Q2 is on and DC1 is now activated. Throughout this sequence, Pin 12 of IC1C remains at Logic 1. This, then, is the circuit status for as long as PS1 remains activated. In the event that PS1 becomes de-activated, such as in a power failure, the resultant absence of voltage at R1 makes the input of IC1A a logic 0, which then gets inverted to a 1 by IC1A so that Pin 8 becomes a logic 1, where it will remain for as long as PS1 is off. At this time, Pin 8 of IC1B and Pin 12 of IC1C are both at logic 1. However, since the last 0 was at Pin 8 when PS1 was activated, then the output at Pin 10 remains at 1, which, as previously described, will maintain DC1 in an activated state. At this time, DC1 will run off of power provided by BAT1. Once power is restored, DC1 will continue to operate, only the system will have switched back to power as supplied by PS1 as previously described. After such a power failure occurs, and if BAT1 is rechargeable, R5 provides a means for current to flow back into BAT1 from PS1 once power has been restored so as to recharge the battery. Should it be desired to restore the “sleep” condition, such as prior to when product is to be shipped, this is accomplished by removing power from PS1 and then momentarily pressing PB1. This will reverse the status of the flip flop and restore the sleep condition as previously described. The sleep condition for the battery can also be restored when power from PS1 is removed by temporarily disconnecting and then reconnecting the battery.

This, then, describes the operation of the circuit. If desired, other capabilities can be added as well. For example, another momentary pushbutton switch could be connected to the junction of R1, R2 and the input of IC1A. The other connection on this pushbutton switch would be made to “+” (positive) side of the battery. This pushbutton switch would provide a means of re-connecting the battery electrically without the presence of power to PS1. Another capability would be to provide the control circuit with a sleep state switching circuit having the ability to automatically put BAT1 into sleep mode if the battery is becoming too discharged while operating DC1 during a prolonged power failure. This could easily be accomplished by adding a comparator, a resistor network, connected across BAT1 to function as a voltage divider, and a fixed voltage reference to the circuit. The voltage reference would be connected to the “−” (inverting) input of the comparator and the junction of the voltage divider resistors would be connected to the “+” (non-inverting) input of the comparator. The output of the comparator would be connected to Pin 12 of IC1C. Resistor values and voltage reference would be selected in accordance with requirements so that operation would be as follows: A fully charged battery would generate a voltage at the “+” (non-inverting) input of the comparator that is higher than the voltage generated at the “−” (inverting) input by the voltage reference. As a result, the output of the comparator would be a 1. As the BAT1 discharges from driving DC1, the voltage at the “+” (non-inverting) input would gradually drop. When this voltage dropped below the voltage reference voltage on the “−” (inverting) input, the output of the comparator would change to a 0, and this would have the same effect as pressing PB1, which would put BAT1 into sleep mode. This added capability would prevent BAT1 from becoming completely discharged in a prolonged power failure. A preferred configuration of the aforementioned capability is as shown in FIG. 2 wherein the aforementioned components are contained within the device circuitry, DC1. When so configured, these circuit components will only be active when power is being supplied by PS1 or by BAT1 as in during a power failure. Therefore, these components will not cause any additional current drain on BAT1 when the circuitry is in the sleep condition. Referring to FIG. 2, IC2 is a comparator such as an LM339, R6 and R7 are resistors comprising the voltage divider connected to the “−” inverting input (Pin 6), and a Zener diode or other voltage reference component VR1 (such as an LM285Z), combined with resistor R8, provides a fixed voltage reference connected to the “+” non-inverting input (Pin 7). Note that Pin 12, which is the operating voltage connection for IC2, as well as R6 and R8, are all connected to the collector of Q2 and therefore, as previously mentioned, are only powered when PS1 is activated or when BAT1 is operating the system in a power failure. With reference to IC2, other comparators may be utilized as well, but the LM339 is suitable because it has a wide operating voltage range (2-36 VDC, typical), making it suitable for application in power supply/battery configurations of different voltages. The selection of values of R6 and R7 and the value of the reference voltage of VR1 will vary depending upon the operating voltage of PS1 and BAT1 and the desired minimal voltage at which BAT1 would be returned to the sleep condition as it discharges during a prolonged power failure. The value of R8, while not critical, would be in the range of 10K ohms. It is also preferred that resistor R9 is added between the output (Pin 1) of IC2 and the input (Pin 12) of IC1, as this will help to limit the current that will flow when the output of IC2 changes state as a discharging battery reaches the threshold point where it is returned to the sleep condition. The value of R9, while not critical, must be very low (such as 100 ohms) compared to the value R3 (also not critical, but may be a value such as 100K ohms) so that a voltage divider is not created between R9 and R3 at the input of IC1C (Pin 12) which would affect the logic 0 condition generated by IC2 in a “return to battery sleep” condition caused by a suitably discharged battery. This logic 0 condition thus generated at the input of IC1C (Pin 12) is essential for automatically returning the battery to the sleep condition in a prolonged power failure.

Although illustrative embodiments of the present invention have been described herein with reference to the accompanying drawing, it is to be understood that the invention is not limited to those precise embodiments, and that various other changes and modifications may be effected therein by one skilled in the art without departing from the scope or spirit of the invention.

What is claimed is:

1. A control circuit for selectively allowing a backup battery to be physically, connected to a load without being electrically connected to the load, which comprises:
a bistable multivibrator circuit, the bistable multivibrator circuit having a first input, a second input and an output, the bistable multivibrator circuit generating an output signal on the output thereof in response to signals provided on the first and second inputs thereof, the second input receiving a power supply signal in response to a power supply supplying a voltage to the control circuit, the first input receiving a delayed signal in delayed response to one of the power supply supplying the voltage to the control circuit and the backup battery supplying a voltage to the control circuit; and
a power-to-load switching circuit, the power-to-load switching circuit being responsive to the output signal generated by the bistable multivibrator circuit and selectively providing one of the power supply voltage and the backup battery voltage to the load in response thereto;
wherein the bistable multivibrator circuit is in a first sleep state when the multivibrator circuit receives the delayed signal on the first input thereof prior to the multivibrator circuit receiving the power supply signal on the second input thereof, whereby the control circuit provides no power supply voltage and no backup battery voltage to the load; and
wherein the bistable multivibrator circuit changes from the first sleep state to a second state when the multivibrator circuit receives the power supply signal on the second input thereof after the multivibrator circuit is already in the first state, whereby the control circuit provides one of the power supply voltage and the backup battery voltage to the load.

2. A control circuit as defined by claim 1, which further comprises:
a delay circuit, the delay circuit being responsive to one of the power supply voltage and the backup battery voltage and providing the delayed signal in delayed response thereto to the first input of the bistable multivibrator circuit.

3. A control circuit as defined by claim 2, wherein the delay circuit includes an integrator circuit.

4. A control circuit as defined by claim 1, which further comprises:
an analog signal-to-logic signal conversion circuit, the conversion circuit being responsive to the voltage generated by the power supply and providing the power supply signal in response thereto to the second input of the bistable multivibrator circuit.

5. A control circuit as defined by claim 4, wherein the analog signal-to-logic signal conversion circuit includes a resistor divider network.

6. A control circuit as defined by claim 1, which further comprises:
a sleep state switching circuit, the sleep state switching circuit selectively generating a sleep state signal provided to the first input of the bistable multivibrator circuit, the bistable multivibrator circuit changing from the second state to the first sleep state when the multivibrator circuit receives the sleep state signal on the first input thereof after the multivibrator circuit is already in the second state.

7. A control circuit as defined by claim 6, wherein the sleep state switching circuit includes a switch.

8. A control circuit as defined by claim 6, wherein the sleep state switching circuit includes a comparator circuit, the comparator circuit comparing the backup battery voltage with a threshold voltage and generating the sleep state signal in response thereto.

9. A control circuit for selectively allowing a backup battery to be physically connected to a load without being electrically connected to the load, which comprises:
a bistable multivibrator circuit, the bistable multivibrator circuit having a first input, a second input and an output, the bistable multivibrator circuit generating an output signal on the output thereof in response to signals provided on the first and second inputs thereof, the second input receiving a power supply signal in response to a power supply supplying a voltage to the control circuit, the first input receiving a delayed signal in delayed response to one of the power supply supplying the voltage to the control circuit and the backup battery supplying a voltage to the controlled circuit;
a power-to-load switching circuit, the power-to-load switching circuit being responsive to the output signal generated by the bistable multivibrator circuit and selectively providing one of the power supply voltage and the backup battery voltage to the load in response thereto;
a delay circuit, the delay circuit being responsive to one of the power supply voltage and the backup battery voltage and providing the delayed signal in delayed response thereto to the first input of the bistable multivibrator circuit;
an analog signal-to-logic signal conversion circuit, the conversion circuit being responsive to the voltage generated by the power supply and providing the power supply signal in response thereto to the second input of the bistable multivibrator circuit; and
a sleep state switching circuit, the sleep state switching circuit selectively generating a sleep state signal provided to the first input of the bistable multivibrator circuit, the sleep state switching circuit being one of a switch and a comparator circuit, the comparator circuit comparing the backup battery voltage with a threshold voltage and generating the sleep state signal in response thereto;
wherein the bistable multivibrator circuit is in a first sleep state when the multivibrator circuit receives the delayed signal on the first input thereof prior to the multivibrator circuit receiving a power supply signal on the second input thereof, whereby the control circuit provides no power supply voltage and no backup battery voltage to the load;
wherein the bistable multivibrator circuit changes from the first sleep state to a second state when the multivibrator circuit receives the power supply signal on the second input thereof after the multivibrator circuit is already in the first state, whereby the control circuit provides one of the power supply voltage and the backup battery voltage to the load; and
wherein the bistable multivibrator circuit changes from the second state to the first sleep state when the multivibrator circuit receives the sleep state signal on the first input thereof after the multivibrator circuit is already in the second state.
